(19) United States
(12) Patent Application Publication
(10) Pub. No.: US 2021/0204095 A1
(43) Pub. Date: Jul. 1, 2021

(54) MANAGING SENSOR AND/OR ACTUATOR DEVICES

(71) Applicant: HERE GLOBAL B.V., Eindhoven (NL)

(72) Inventor: Marko LUOMI, Lempäälä (FI)

(73) Assignee: HERE GLOBAL B.V., Eindhoven (NL)

(21) Appl. No.: 17/058,470

(22) PCT Filed: May 25, 2018
(86) PCT No.: PCT/EP2018/063824

§ 371 Date: Nov. 24, 2020

(51) Int. Cl. H04W 4/029; G01S 5/02

(52) U.S. Cl. CPC H04W 4/029; G01S 5/0284; G01S 5/0252

(57) ABSTRACT

A method is disclosed, performed by at least a first apparatus, for managing at least a second apparatus, the second apparatus being a sensor and/or actuator device or a part thereof, the method comprising: obtaining identifier information of the second apparatus and obtaining positioning information associated with the identifier information and indicative of a position of the second apparatus; determining updated positioning information of the second apparatus at least based on an obtained radio measurement taken by the second apparatus; and at least based on the updated positioning information of the second apparatus, determining whether the second apparatus has been relocated and/or updating the positioning information associated with the identifier information of the second apparatus.

### FIELD OF THE INVENTION

The invention is related to sensor and/or actuator devices, which are in particular deployed for creating an infrastructure for the Internet of Things, and which may be utilized in the field of positioning technologies, in particular indoor positioning.

### BACKGROUND OF THE INVENTION

Indoor positioning requires novel systems and solutions that are specifically developed and deployed for this purpose. The traditional positioning technologies, which are mainly used outdoors, i.e. satellite and cellular positioning technologies, cannot deliver such performance indoors that would enable seamless and equal navigation experience in both environments. The required positioning accuracy (2-3 m), coverage (˜100%) and floor detection are challenging to achieve with satisfactory performance levels with the systems and signals that were not designed and specified for the indoor use cases in the first place. Satellite-based radio navigation signals simply do not penetrate through the walls and roofs for the adequate signal reception and also cellular and WiFi signals are attenuated inside, which makes positioning based on those signals less reliable inside.

Several indoor-dedicated solutions have already been developed and commercially deployed during the past years e.g. solutions based on technologies like pseudolites (GPS-like short-range beacons), ultra-sound positioning, Bluetooth or Bluetooth LE signals and Wi-Fi fingerprinting. What is typical to these solutions is that they require either deployment of totally new infrastructure (such as beacons or tags) or manual exhaustive radiosurveying of the buildings including all the floors, spaces and rooms. This is rather expensive and will take a considerable amount of time to build the coverage to the commercially expected level, which can in some cases narrows the potential market segment to only a very thin customer base e.g. for health care or dedicated enterprise solutions. Also, the diversity of these technologies makes it difficult to build a globally scalable indoor positioning solution, and the integration and testing will become complex if a large number of technologies needs to be supported in the consumer devices, such as smartphones.

For an indoor positioning solution to be commercially successful it needs to be globally scalable, have low maintenance and deployment costs, and offer acceptable end-user experience. This can best be achieved, if the solution is based on an existing infrastructure in the buildings and on existing capabilities in the consumer devices. Accordingly, the indoor positioning needs to be based on technologies like Wi-Fi- and/or Bluetooth (BT)-technologies that are already supported in almost every smartphone, tablet, laptop and even in the majority of the feature phones. It is, thus, required to find a solution that uses such radio signals in such a way that makes it possible to achieve 2-3 m horizontal positioning accuracy, close to 100% floor detection with the ability to quickly build the global coverage for this approach.

One approach for radio-based indoor positioning models e.g. the Wi-Fi-radio environment (or any similar radio e.g. Bluetooth) from observed Received Signal Strength (RSS)-measurements as 2-dimensional radio maps and is hereby able to capture the dynamics of the indoor radio propagation environment in a compressable and highly accurate way. This makes it possible to achieve unprecedented horizontal positioning accuracy with the radio signals only within the coverage of the created radio maps and also gives highly reliable floor detection.

Huge volumes of indoor radio signal measurement data (so called fingerprints) can be harvested via crowd-sourcing if the consumer devices are equipped with the necessary functionality to enable the radio signal data collection as a background process, naturally with the end-user consent. It could also be possible to use volunteers to survey the sites (buildings) in exchange of reward or recognition and get the coverage climbing up globally in the places and venues important for the key customers. However, the technical challenges related to the harvesting, processing, redundancy, ambiguity and storing the crowd-sourced data need to be understood and solved first, before the radio map creation can be based on the fully crowd-sourced data.

Management of a large number of devices (e.g. beacons) of an infrastructure is difficult and prone to errors. For instance, manually entering the positions of the devices to a database requires a lot of effort, and when time goes by the devices are moved or replaced, so that the information about the position of the devices will easily be lost.

In any case, independent of whether there is a manually deployed dedicated infrastructure or an existing infrastructure originally deployed for a different purpose (i.e. not originally intended for use as a positioning technology, for instance), there is the challenge of managing the deployed infrastructure, i.e. for instance registering and/or maintaining up-to-date information about the existing or deployed infrastructure, such as information about the position or location of every device of the infrastructure.

### SOME EXAMPLE EMBODIMENTS OF THE INVENTION

Certain aspects or embodiments of the invention allow for improving the positioning performance (e.g. accuracy) of an existing or deployed infrastructure. Certain aspects or embodiments of the invention allow for improving managing (i.e. for instance installing, registering and/or maintaining) an existing or deployed infrastructure, which may comprise a plurality of devices.

According to a first exemplary aspect of the invention, a method is disclosed, performed by at least a first apparatus, for managing at least a second apparatus, the second apparatus being a sensor and/or actuator device, the method comprising:
obtaining identifier information of the second apparatus and obtaining positioning information indicative of a position of the second apparatus and associated with the identifier information;
determining updated positioning information of the second apparatus at least based on an obtained radio measurement taken by the second apparatus; and
at least based on the updated positioning information of the second apparatus, determining whether the second apparatus has been relocated and/or updating the positioning information associated with the identifier information of the second apparatus.

According to a second exemplary aspect of the invention, a method for supporting managing at least a second apparatus at a first apparatus is disclosed, the second apparatus being a sensor and/or actuator device, the method performed by the second apparatus, the method comprising:
providing identifier information of the second apparatus to a third apparatus;
taking a radio measurement;
providing identifier information of the second apparatus and the radio measurement to the first apparatus;
providing sensor data to the first apparatus and/or obtaining actuator data from the first apparatus;
automatically and repeatedly taking further radio measurements and providing the further taken radio measurements to the first apparatus.

According to a third exemplary aspect of the invention, a method for registering at least a second apparatus at a first apparatus is disclosed, the second apparatus being a sensor and/or actuator device, the method performed by a least a third apparatus, the method comprising:
receiving, from the second apparatus, identifier information of the second apparatus;
determining positioning information indicative of a position of the second apparatus by positioning the third apparatus; and
providing the identifier information of the second apparatus and the positioning information indicative of a position of the second apparatus to the first apparatus.

The method according to the first aspect may also be referred to as the first method. The method according to the second aspect may also be referred to as the second method. The method according to the third aspect may also be referred to as the third method. The first, second and/or third method may for instance be performed and/or controlled by an apparatus according to the exemplary aspects described below.

According to any aspect of the invention, an apparatus is also disclosed, comprising means for performing the method according to any exemplary aspect of the invention. The means of the apparatus may be implemented in hardware and/or software. They may comprise for instance at least one processor for executing computer program code for realizing the required functions, at least one memory storing the program code, or both. Alternatively, they could comprise for instance circuitry that is designed to realize the required functions, for instance implemented in a chipset or a chip, like an integrated circuit. In general, the means may comprise for instance one or more processing means such as a processor and a memory. Optionally, the apparatus may comprise various other components, like a communication interface, a network interface, a radio interface, a data interface, a user interface etc.

According to any aspect of the invention, an alternative apparatus is also disclosed, comprising at least one processor and at least one memory including computer program code, the at least one memory and the computer program code configured to, with the at least one processor, cause the apparatus to at least perform the method according to any exemplary aspect of the invention.

The above-disclosed apparatuses according to any aspect of the invention may be a module or a component for a device, for example a chip. Alternatively, the disclosed apparatus according to any aspect of the invention may be a device, for instance a mobile device or a server. The disclosed apparatus according to any aspect of the invention may comprise only the disclosed components, for instance means, processor, memory, or may further comprise one or more additional components.

According to any aspect of the invention, a computer program code, the computer program code, when executed by a processor, causing an apparatus to perform the method according to any exemplary aspect of the invention.

The computer program may be stored on a computer-readable storage medium, in particular a tangible and/or non-transitory medium. The computer readable storage medium could for example be a disk or a memory or the like. The computer program could be stored in the computer readable storage medium (e.g. according to the exemplary aspect of the invention) in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to any aspect of the invention, a non-transitory computer readable storage medium is disclosed, in which computer program code is stored, the computer program code when executed by a processor causing at least one apparatus to perform the method according to any exemplary aspect. The storage medium may be a tangible storage medium, for example a tangible computer-readable storage medium. The storage medium may be a storage medium of a mobile device, for example an apparatus according to the exemplary aspects of the invention.

According to a further exemplary aspect of the invention, a system is disclosed, comprising:
a first apparatus;
a second apparatus; and
optionally a third apparatus;

the first apparatus, the second apparatus and the optionally third apparatus together being configured for performing the method according to any exemplary aspect of the invention.

According to an exemplary embodiment of the different aspects of the invention, the first apparatus is a server or a part thereof. For instance, the first apparatus may be positioned remote from the second apparatus. The server may be realized by one or more computers or a computer cloud, for instance.

According to an exemplary embodiment of the different aspects of the invention, the third apparatus is a mobile device or a part thereof. A mobile device may in particular be a mobile terminal. The mobile device may for instance be a smartphone, a smart watch, a tablet, a notebook, a wearable or the like.

Managing of at least a second apparatus may for instance comprise e.g. registering and/or maintaining the second apparatus or information thereon. Therein, managing the second apparatus may comprise or consist of e.g. managing information related to or associated with the second apparatus. Thus, managing the second apparatus may in particular comprise or consist of obtaining and/or updating information about the second apparatus. As will be explained below, the second apparatus is preferably a second apparatus of a plurality of second apparatuses.

More specifically, the second apparatus is in one example part of an Internet of Things (IoT), which may be a local or global infrastructure, allowing the interconnection between physical and virtual objects, such that they may cooperate by means of information and communication technology. The second apparatus may thus be an object of the IoT or an IoT device or may for instance be associated with an object of the Internet of Things. For instance, the second apparatus may be uniquely identifiable through its embedded computing system but is able to inter-operate within the existing Internet infrastructure.

One specific characteristic of an IoT device may be the low bandwidth used for communication. Another characteristic of an IoT device may be the high power efficiency, i.e. the low power requirement. IoT devices typically need to be extremely power-efficient so that their battery lasts for extended periods. One of the mechanisms to reduce power consumption is to use low-bandwidth connectivity networks that have especially been designed for IoT devices. In practice, low-bandwidth means a limited payload size per message and/or a limited number of messages per day.

In one example, the second apparatus may be a sensor device. For this, the second apparatus may comprise one or more sensors, which may collect sensor data locally observed in the environment of the second apparatus and provide the sensor data e.g. to the first apparatus. Additionally or alternatively, the second apparatus may be an actuator device. For this, the second apparatus may comprise at least one actuator, which may for instance be a component of a machine that is responsible for moving and/or controlling a mechanism or a mechanical system.

The second apparatus (i.e. radio signals emitted form the second apparatus or a plurality of second apparatuses) may be utilized by a nearby (mobile) device observing the emitted signals of the second apparatus for positioning purposes in combination with a respective radio map.

Identifier information of the second apparatus is understood to be information allowing to (e.g. uniquely) identify the second apparatus, such as a registration number. The identifier information may however also depend on the communication technologies employed by the second apparatus. Non-limiting examples of identifier information may for instance comprise a mobile identification number (MIN), a mobile subscription identification number (MSIN) or an International Mobile Equipment Identity (IMEI) or a part thereof, e.g. in case a cellular mobile telecommunications system is used for the communication of the second device. A further example of identifier information is a Medium Access Control (MAC) address. The identifier information may globally or locally uniquely identify the second apparatus. The first method may in this regard also comprise obtaining identifier information of the second apparatus, e.g. from the third apparatus, as will be explained in more detail further below.

The positioning information is indicative of a position of the second apparatus. The positioning information may be representative of a geographical position on the surface of the earth. The positioning information may comprise e.g. latitude, longitude and/or altitude information. The positioning information may be absolute positioning information. The positioning information may be based on a source reliable enough so that no further information is required to sufficiently determine a position. As the positioning information only needs to be indicative of a position of the second apparatus, the positioning information may not necessarily be determined by the second apparatus itself, but e.g. also from an apparatus close to the second apparatus, as will be explained in more detail further below. The first method may in this regard also comprise obtaining the positioning information of the second apparatus.

The obtained identifier information of the second apparatus is associated with the obtained positioning information indicative of a position of the second apparatus. Accordingly, the identifier information and positioning information may be stored in association with each other by the first device, e.g. in a common data set of a database, which may be part of and/or maintained by the first apparatus and which may be accessed by the first apparatus, for instance. The database thus has information about most recent positons of respective second devices (identified by the identifier information).

The described action of obtaining the identifier information of the second apparatus and the positioning information indicative of a position of the second apparatus may be understood as a process of registering (which may also comprise a potential re-registering, for example, but will only referred to as registering in the following) the respective second apparatus at the first device. The positioning information may thus be understood as initial positioning information (in contrast to the updated positioning information which may be determined later on). Advantageously, it is not necessary that the second device knows or determines the positioning information indicative of its own position, as will be explained in more detail below.

After the first apparatus has associated the obtained identifier information with the obtained positioning information, the first apparatus may assume that the positioning information is the correct or up-to-date positioning information of the second apparatus.

A radio measurement may be understood to be radio signal measurement data. For instance, a radio measurement may comprise a radio measurement of one or more radio signals. A radio measurement may be understood to be a radio fingerprint. A radio measurement taken by the second apparatus may comprise a measurement of the radio environment of the second apparatus. A radio measurement may comprise a measurement of one or more signals observable at the position, at which the measurement was taken (i.e. at the second apparatus). The radio measurement may comprise one or more characteristics of the observed radio signal(s). For instance, a characteristic of a radio signal may be the signal strength of received signals (received signal strength indication RSSI or physical Rx level), path losses and/or timing measurements like propagation delay, timing advance (TA) or round-trip time (RTT). The radio measurement may alternatively or additionally comprise an identifier of the emitter of the respective radio signal. Non limiting examples of such identifiers are a Cell Identity CID, such as UTRAN Cell ID (UC-ID) or an LTE Cell Identity in case of cellular communication systems or a (basic) service set identification (BSSID or SSID), a medium access control (MAC) address in case of non-cellular communication system. The radio measurement may in particular be taken from a communication network, which is used by the second apparatus to communicate (e.g. with the first apparatus). The first method may in this regard also comprise obtaining the radio measurement taken by the second apparatus.

Based on an obtained radio measurement e.g. in connection with a radio map (to determine the position of the second apparatus position information can be determined e.g.) a more recent one than the one already available. A radio map may allow for deriving positioning information based on an obtained radio measurement. For this the radio map may either associate respective geographical positions with respective radio measurements (which may be measured or interpolated) or comprise model data for modeling and deriving the expected radio measurement for a specific geographical position.

Additionally or alternatively, any radio measurement obtained at the first apparatus (e.g. taken by the second and/or third apparatus and received at the first apparatus from the second and/or third apparatus) may also be used for updating the radio map at the first apparatus. This may in particular be the case, if the obtained radio measurement itself is not needed for determining a position indicated by the radio measurement, but the position at which the radio measurements was taken is already known e.g. from another source. For instance, a radio measurement (e.g. of the second communication system, such as a LPWAN) taken at the second apparatus and received at the first apparatus may be used for updating a respective radio map. For instance a radio measurement (e.g. of the first communication system or any communication system, which is used by the third apparatus to determine its position) taken at the third apparatus and received at the first apparatus may be used for updating a respective radio map.

According to an exemplary embodiment, the updated positioning information may be used to determine whether the second apparatus has been relocated, e.g. by comparing the previously obtained positioning information and the determined updated positioning information. This can be utilized for taking further actions, such as notifying a user of the detected relocation. Such a relocation may generally be done advertently, e.g. by a service crew member, but also inadvertently.

Alternatively or additionally and according to an exemplary embodiment, the positioning information associated with the identifier information of the second apparatus may be updated. For instance, the determined updated positioning information may be associated with the identifier information of the second apparatus. For instance, in one embodiment the updating may only be performed in case it is determined that the second apparatus has been relocated.

In case the second apparatus is relocated a re-registering can advantageously be avoided, since the updated positioning information can be determined automatically and does not need to be provided manually, which may be prone to errors. If a relocation is not accounted for, another device utilizing signals emitted by the second apparatus for positioning will result in erroneous positioning results or results with reduced accuracy, since the radio environment changes due to the relocation.

The described action of determining and/or updating may be understood to be a process of maintaining the second apparatus (in particular positioning information about the second apparatus) at the first apparatus.

Generally, the action of obtaining respective information may for instance be or comprise receiving respective information from a different entity or apparatus. The action of providing respective information may for instance be or comprise sending respective information to a different entity or apparatus.

According to an exemplary embodiment of the different aspects of the invention, the method further comprises:
obtaining sensor data from the second apparatus and/or providing actuator data to the second apparatus.

As explained, the second apparatus is a sensor and/or actuator device. The second apparatus may by means of a sensor continuously and/or repeatedly measure a parameter of its surrounding. For this, the second apparatus may provide sensor data, e.g. comprising information on the measured parameter, to the first apparatus, which may in turn obtain the respective sensor data. Alternatively or additionally, the second apparatus may continuously and/or repeatedly control an actuator. For this, the first apparatus may provide actuator data, e.g. comprising information on the actuator control, to the second apparatus, which may in turn be obtained by the second apparatus.

The sensor and/or actuator data may in particular be different from the described radio measurements and/or (updated) positioning information. By way of example, the sensor may be a mechanical, thermoelectric, resistive, capacitive, inductive, optical, acoustic and/or magnetic sensor, for instance. Examples of a sensor are a temperature sensor, a humidity sensor, a pressure sensor, a movement sensor, a light sensor, to name a few examples. By way of example, the actuator may be an electromechanical, electrochemical, inductive, magnetic, hydraulic, pneumatic and/or thermal actuator. Examples of an actuator are an electric motor, a hydraulic cylinder, a solenoid or a piezoelectric actuator, to name a few examples.

According to an exemplary embodiment of the different aspects of the invention, the identifier information of the second apparatus is obtained from a third apparatus, the third apparatus having obtained the identifier information from the second apparatus.

For instance, the identifier information may be obtained from the third apparatus at the first apparatus only for the purpose of registering the second apparatus at the first apparatus. The third apparatus may be a mobile device, which may only be used for registering the second apparatus at the first apparatus. The third apparatus may in particular have its own positioning capabilities. For instance, the identifier information only needs to be obtained from the third apparatus once (or until a further registering of the second apparatus), so that the positioning information indicative of a position of the second apparatus (which may also be sent by the third device) can be assigned to the correct second apparatus. After the process of registering, the identifier information of the second apparatus may be received directly form the second apparatus, e.g. in connection with radio measurements taken by the second apparatus.

While the identifier information may generally be obtained by the third apparatus in different ways (e.g. input into the third apparatus manually by a user of the third apparatus), it is preferred that the third apparatus obtains the identifier information (directly) from the second apparatus. Thus, necessary manual steps are reduced and errors in the registering process can be avoided.

According to an exemplary embodiment of the different aspects of the invention, the identifier information is obtained at the third apparatus from the second apparatus based on radio-frequency identification technology. In one example, the Near Field Communication (NFC) standard may be used for obtaining the identifier information at the third apparatus. For instance, the second apparatus may comprise an RFID tag or transponder (e.g. NFC tag) storing the identifier information of the second device so that they can be (e.g. actively or passively) provided to the third apparatus. The identifier information may be read from the RFID tag by the third apparatus with a corresponding reader.

According to an exemplary embodiment of the different aspects of the invention, the obtained positioning information indicative of a position of the second apparatus is obtained from a third apparatus (e.g. the third apparatus already described). The third apparatus may not only be used for providing (particularly during a registering process) the identifier information to the first apparatus, but also the positioning information indicative of a position of the second apparatus. This is particularly advantageous, because particularly during a registering process of the second apparatus, positioning information may not be available the second apparatus and the positioning information may advantageously be determined by the third apparatus itself (as described below).

According to an exemplary embodiment of the different aspects of the invention, the obtained positioning information indicative of a position of the second apparatus is determined by positioning a third apparatus (e.g. the third apparatus already described). As explained, the positioning information indicative of a position of the second apparatus does not necessarily need to be determined by the second apparatus itself and/or does not necessarily need to be the (exact) position of the second apparatus. Rather, it is sufficient to assume that a position of the third apparatus (particularly during a registering process) is sufficiently close to the position of the second apparatus. This is particularly true, in case the identifier information is obtained at the third apparatus from the second apparatus based on radio-frequency identification technology. For instance, the third apparatus may perform a positioning of itself in order to obtain positioning information indicative of a position of the second apparatus. The positioning of the second apparatus may for instance be an online or offline positioning. The positioning of the second apparatus may for instance be based on a technology suitable for outdoor and/or indoor positioning.

According to an exemplary embodiment of the different aspects of the invention, the positioning of the third apparatus is based on at least one of
a cellular communication system;
a non-cellular communication system; and/or
a global navigation satellite system.

The third apparatus may receive signals of the respective system and determine (optionally with the support of a positioning server), based on the received signals, a corresponding position of the third apparatus which may then be used as positioning information indicative of a position of the second apparatus.

Examples of a cellular communication system or network are a second generation (2G, for instance the Global System for Mobile Communication (GSM), the General Packet Radio System (GPRS), the Enhanced Data Rates for GSM Evolution (EDGE) or the High Speed Circuit-Switched Data (HSCSD)), third generation (3G, for instance the Universal Mobile Telecommunication System, UMTS, WCDMA, TD-SCDMA or CDMA-2000), fourth generation (4G, for instance the Long Term Evolution, LTE system, the LTE Advanced (LTE-A) system or the IEEE 802.16m WiMAX system) or fifth generation (5G) communication system.

Examples of a non-cellular communication system or network are a WLAN system, a Bluetooth (LE) system, a ZigBee system, a radio-frequency identification (RFID) system, a broadcasting network such as for instance Digital Video Broadcasting (DVB), Digital Audio Broadcasting (DAB) or Frequency-Modulated (FM)/Amplitude-Modulated (AM) system, a Near Field Communication (NFC) system, etc.

A cellular communication system may for instance be characterized by a basically seamless pavement of a geographical area (usually in the order of at least hundreds or thousands of square kilometers) with cells in which coverage is provided by respective nodes of the communication system that are operated by the same operator, which network may for instance support communication handover between cells. Consequently, a non-cellular communication system may be characterized as a communication system that does not have all of these properties.

Examples of global navigation satellite system (GNSS) are “Global Positioning System” (GPS), “Galileo”, “Global Navigation Satellite System” (i.e. “Globalnaja Nawigazionnaja Sputnikowaja Sistema”, GLONASS), “BeiDou Navigation Satellite System” (BDS), or “Quasi-Zenith Satellite System” (QZSS), to name some examples.

According to an exemplary embodiment of the different aspects of the invention, the third apparatus communicates with the first apparatus at least in part based on at least one of
a cellular communication system; and/or
a non-cellular communication system.

Examples of a cellular communication system, for instance a second generation, third generation, fourth generation or fifth generation communication system, have already been described above and it is referred to the above described examples of cellular communication systems. Examples of a non-cellular communication system or networks (such as WLAN, Bluetooth (LE), a ZigBee or RFID) have also been described above and it is referred to the above described examples of non-cellular communication systems. The communication between the third apparatus and the first apparatus may for instance be a one way or two way communication. The communication system between the third apparatus and the first apparatus may be referred to as the first communication system.

According to an exemplary embodiment of the different aspects of the invention, the method further comprises:
obtaining, from the second apparatus, identifier information of the second apparatus and a radio measurement taken by the second apparatus,
associating the obtained positioning information with the obtained radio measurement.

The identifier information may be the identifier information, which may be obtained at the first apparatus in association with the obtained (initial) positioning information (e.g. from the third apparatus), as already described. By obtaining the identifier information, the first apparatus can identify the second apparatus. Specifically, the first apparatus can associate the obtained radio measurement taken by the second apparatus with the obtained (initial) positioning information (obtained e.g. from the third apparatus).

By associating positioning information and an (initial) radio measurement, a radio measurement or fingerprint for a specific position is obtained. Particularly, if the described method is performed for a plurality of second apparatuses, i.e. a plurality of radio measurements for respective positions of the respective plurality of second apparatuses are obtained at the first apparatus, a crowd sourcing can be realized.

For this purpose, the first apparatus may have access to and/or maintain a positioning database (which may have the form of a radio map or allow creating a radio map), which may be updated with respective obtained radio measurements. With the information of the positioning database in connection with one or more obtained radio measurements an updated position of a relocated second apparatus may be determined.

The second apparatus may communicate with the first apparatus at least in part over a second communication system. The communication between the second and the first apparatus may for instance be a one way or two way communication. The second communication system may for instance be a cellular or non-cellular communication system. Examples of a cellular communication system, for instance a second generation, third generation, fourth generation or fifth generation communication system, have already been described above and it is referred to the above described examples of cellular communication systems. Examples of a non-cellular communication system or networks (such as WLAN, Bluetooth (LE), a ZigBee or RFID) have also been described above and it is referred to the above described examples of non-cellular communication systems.

According to an exemplary embodiment of the different aspects of the invention, the second apparatus communicates with the first apparatus at least in part via a low power wide area network (which may be a second communication system).

A Low-Power Wide-Area Network (LPWAN), also called a Low-Power Wide-Area (LPWA) network or Low-Power Network (LPN) is a type of wireless communication network designed to allow long range communications at a low bit rate among things (connected objects), such as sensor and/or actuator devices (such as the second apparatus), particularly if operated on battery power. A LPWAN may be a cellular or non-cellular network. The low power, low bit rate and intended use distinguish this type of network from e.g. a wireless WAN or LAN that is designed to connect users or businesses, and carry more data, using more power. In exemplary embodiments, the LPWAN data rate (i.e. for communication between the first and the second apparatus) may be limited to 2 Mbit/s or less, 1 Mbit/s or less, or even 250 kbit/s or less. The data rate may for instance be a maximum or achievable data rate. The described data rates may thus in particular be used for providing or obtaining the data described herein.

According to an exemplary embodiment of the different aspects of the invention, the radio measurements taken by the second apparatus are based on signals of a low power wide area network. For instance, the LPWAN is the same LPWAN described above and used for the communication between the second apparatus and the first apparatus. It may also generally be the case, that in exemplary embodiments the radio measurements taken by the second apparatus are based on signals of the (second) communication system used for communication between the second apparatus and the first apparatus (which may generally be any of the described cellular or non-cellular communication systems).

In exemplary embodiments, the second apparatus may only be able to communicate and/or take radio measurements based on a single communication network, such as the low power wide area network.

According to an exemplary embodiment of the different aspects of the invention, the low power wide area network is based on at least one of:
a chirp spread spectrum based system;
a LoRa based system;
an ultra narrow band based system;
a Sigfox system;
a Telensa system;
a NarrowBand-IoT system, e.g. LTE Cat M1;
an Nwave system;
a Weightless system.

As already described, a Low Power Wide Area Network (LPWAN) is in particular understood to be a wireless communication wide area network (e.g. cellular or non-cellular) designed to allow long range communications (e.g. over hundreds of meters or over kilometers) at a low bit rate among things (connected objects). Frequencies employed may in particular be in the MHz regime (e.g. 868 MHz or 902 MHz).

The Low Power Wide Area Network may for instance be based on LoRa technology (e.g. LoRaWAN), which is a chirp spread spectrum (CSS) radio modulation technology. Alternatively, the Low Power Wide Area Network may be based on Ultra Narrow Band (UNB) modulation technology.

One non-limiting example of a Low Power Wide Area Network is a Sigfox network. The frequencies used are 868 MHz and 902 MHz. Such communication supports up to 140 uplink messages a day (from first to second apparatus), each of which can carry a payload of 12 Bytes (excluding message header and transmission information) and up to 4 downlink messages per day (from second to first apparatus), each of which can carry a payload of 8 Bytes.

Another non-limiting example of a Low Power Wide Area Network is a NarrowBand IoT (NB-IoT) network, standardized by the 3rd Generation Partnership Project (3GPP). The NB-IoT technology may be deployed in-band in spectrum allocated to Long Term Evolution (LTE), using resource blocks within a normal LTE carrier (or in the unused resource blocks within a LTE carrier's guard-band) or standalone for deployments in dedicated spectrum. Examples of NB-IoT technologies are LTE Cat 1, LTE Cat 0, LTE Cat M1 (eMTC), LTE Cat NB1 (NB-IoT) or EC-GSM-IoT.

According to an exemplary embodiment of the different aspects of the invention, the first and the third apparatus communicate at least in part via a first communication system and the first and the second apparatus communicate at least in part via a second communication system, wherein the second communication system utilizes a lower data rate and/or allows for a lower power consumption for communication than the first communication system. As described a lower data rate for communication may in particular understood to be a lower maximum or achievable data rate. A lower power consumption for communication may be understood to be a lower (e.g. maximum and/or average) power consumption for sending and/or receiving data, at least for one of the devices (e.g. the second device).

According to an exemplary embodiment of the different aspects of the invention, the first device provides or triggers providing an alert, in case it is determined that the second apparatus has been relocated. The alert may be a notification to a user, e.g. via a user interface e.g. of the first apparatus. A user can then for example check, whether a relocation of the second apparatus has indeed taken place. In that case, the second apparatus may either provide a radio measurement to the first apparatus, so that updated positioning information may be determined by the first apparatus based on the obtained radio measurement. Alternatively, a user may perform a process of (re-)registering the relocated second apparatus, as already described. That is, the user may use a third device in order to obtain, in the proximity of the second device, the identifier information from the second device. The third device may also determine its position to obtain positioning information indicative of a position of the second device. The third device may then provide the identifier information of the second apparatus and the positioning information associated with the identifier information and indicative of a position of the second apparatus to the first apparatus.

According to an exemplary embodiment of the different aspects of the invention, the method is performed for a plurality of second apparatuses. For instance, every action of the described methods is performed for a respective second apparatus of the plurality of second apparatuses. The method allows for a user friendly management of a large number of second apparatuses. Also, the plurality of second apparatuses allows for a crowd sourcing approach and for collecting radio measurements (e.g. of the second communication system).

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE DRAWINGS

FIG. 1 is a block diagram of a system of exemplary apparatuses according to the different aspects;

FIG. 2 is a block diagram of the server of FIG. 1;

FIG. 3 is a block diagram of the sensor and/actuator device of FIG. 1;

FIG. 4 is a block diagram of the mobile device of FIG. 1;

FIG. 5 is a flow chart illustrating the sending and receiving of information between the apparatuses when performing exemplary methods according to the different aspects;

FIG. 6 is a flow chart illustrating an exemplary embodiment of a (first) method according to the first aspect;

FIG. 7 is a flow chart illustrating an exemplary embodiment of a (second) method according to the second aspect;

FIG. 8 is a flow chart illustrating an exemplary embodiment of a (third) method according to the third aspect; and

FIG. 9 is a schematic illustration of examples of tangible storage media according to the invention.

### DETAILED DESCRIPTION OF EXAMPLE EMBODIMENTS OF THE INVENTION

The following description serves to deepen the understanding of the present invention and shall be understood to complement and be read together with the description as provided in the above summary section of this specification.

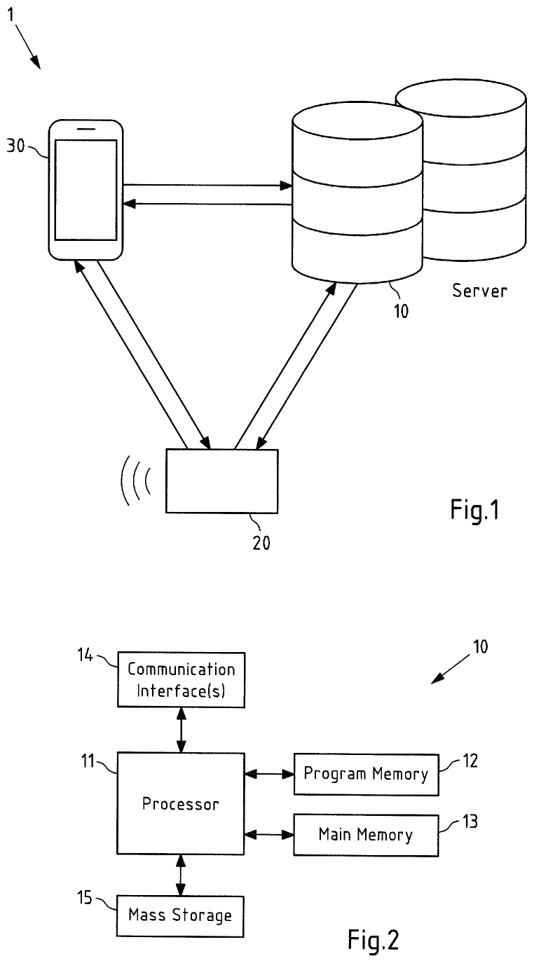

FIG. 1 is a block diagram of a system 1 of a first apparatus 10, which is in this case a server, such as a computer cloud, a second apparatus 20, which is in this case an IoT sensor and/or actuator device and a third apparatus 30, which is in this case a mobile device such as a cellular phone, a personal digital assistant, a laptop computer, a tablet computer or a wearable. In the following, the apparatuses 10, 20 and 30 will be referred to as a server 10, sensor/actuator device 20 and mobile device 30 as examples apparatuses according to the invention. The apparatuses may separately or together perform exemplary embodiments of the different methods according to the invention. Further details of the server 10, the sensor/actuator device 20 and the mobile device 30 are described with respect to FIGS. 2, 3 and 4, respectively, which are exemplary block diagrams of the respective apparatuses.

Server 10 may be a server located remote from sensor/actuator device 20. Mobile device 30 may be at least for a certain time in the proximity (e.g. within a few meters or centimeters) of sensor/actuator device 30.

Turning now to FIG. 2, the server 10 comprises a processor 11. Processor 11 may represent a single processor or two or more processors, which are for instance at least partially coupled, for instance via a bus. Processor 11 executes a program code stored in program memory 12 (for instance program code causing the server to perform embodiments of the (first) method according to the first aspect of the invention, when executed on processor 11), and interfaces with a main memory 13. Some or all of memories 12 and 13 may also be included into processor 11. One of or both of memories 12 and 13 may be fixedly connected to processor 11 or at least partially removable from processor 11. Program memory 12 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Program memory 12 may also comprise an operating system for processor 11. Main memory 13 may for instance be a volatile memory. It may for instance be a RAM or DRAM memory, to give but a few non-limiting examples. It may for instance be used as a working memory for processor 11 when executing an operating system and/or programs.

Processor 11 further interfaces with a mass storage 15, which may be part of the server 10 or remote from server 10, and which may for instance be used to store one or more databases.

For instance, server 10 may store, in a database, collected information from crowd sourcing processes. The database may store identification information of sensor/actuator devices 20 associated with respective geographical positions of the respective sensor/actuator device. The database may be updated with updated positioning information, which may be determined as described with respect to the different aspects of the invention.

Additionally or alternatively, mass storage 15 may be used to store, in a database (e.g. the same or a different database from the database described above) radio measurements of radio signals observed by respective sensor/actuator devices 20 in their environment. This information may be used to create or update a radio map, for instance. The database or the respective radio map can then be used to determine an updated geographical position of the sensor/actuator device 20, also based on radio measurements of radio signals observed by the sensor/actuator device 20.

Processor 11 further controls a communication interface 14 configured to receive and/or output information. For instance, communication interface 14 may be configured to communicate with (e.g. send and/or receive data to/from) sensor/actuator device 20 and/or mobile device 30. This may for instance comprise receiving identifier information, positioning information, radio measurements and/or sensor data. The communication may for instance be based on a (e.g. partly) wireless connection. The communication interface 14 may thus comprise circuitry such as modulators, filters, mixers, switches and/or one or more antennas to allow transmission and/or reception of signals. In embodiments of the invention, communication interface 14 is inter alia configured to allow communication according to a 2G/3G/4G/5G cellular communication system and/or a non-cellular communication system, such as for instance a WLAN network. Nevertheless, the communication route between server 10 and other apparatuses may equally well at least partially comprise wire-bound portions. For instance, server 10 may be connected to a back-bone of one or more wireless communication systems (associated with sensor/actuator device 20 or mobile device 30) via a wire-bound system such as for instance the internet.

The components 12-15 of server 10 may for instance be connected with processor 11 by means of one or more serial and/or parallel busses.

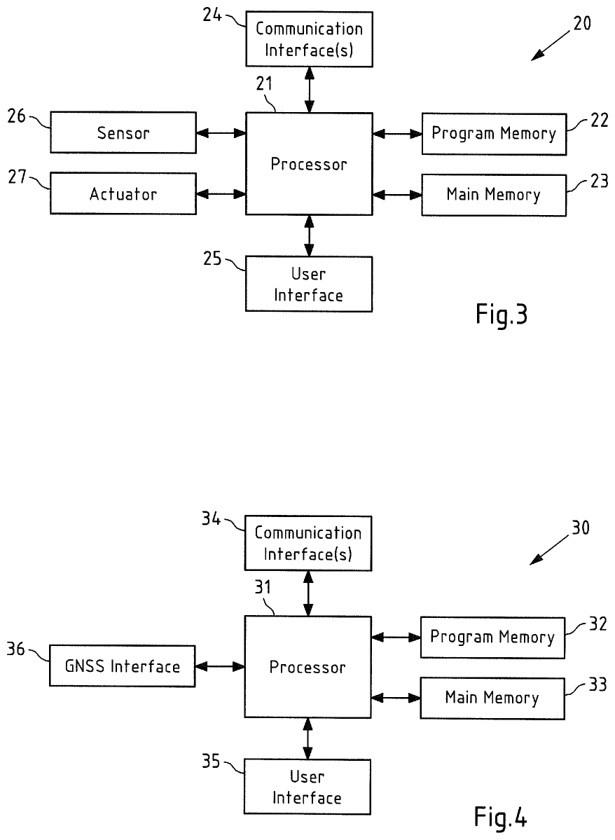

Turning now to FIG. 3, an exemplary block diagram of a sensor/actuator device 20 of FIG. 1 is shown. Similarly to FIG. 2, sensor/actuator device 20 comprises a processor 21. Processor 21 may represent a single processor or two or more processors, which are for instance at least partially coupled, for instance via a bus. Similar to FIG. 2, processor 21 may use program memory 22 and main memory 23 to execute a program code stored in program memory 22 (for instance program code causing sensor/actuator device 20 to perform embodiments of the (second) method according to the second aspect of the invention, when executed on processor 21).

Processor 21 further interfaces with a sensor 26 and an actuator 27. Processor 21 further controls a communication interface 24 configured to receive and/or send information. For instance, sensor/actuator device 20 may be configured to communicate with server 10 and/or mobile device 30 of system 1 of FIG. 1. This may for instance comprise sending identifier information, radio measurements and/or sensor data of sensor 26. Additionally, this may for instance comprise receiving actuator data for actuator 27. The communication may for instance be based on a (e.g. partly) wireless connection. The communication interface 24 may thus comprise circuitry such as modulators, filters, mixers, switches and/or one or more antennas to allow transmission and/or reception of signals. In embodiments of the invention, communication interface 24 is inter alia configured to allow communication according to a 2G/3G/4G/5G cellular communication system and/or a non-cellular communication system, such as for instance a WLAN network. Specifically, the communication interface 24 may configured for communication over a LPWAN.

Processor 21 may further control a user interface 25 configured to present information to a user of sensor/actuator device 20 and/or to receive information from such a user. However, it may also be the case, that the sensor/actuator device, in particular in case of e.g. an IoT device, does not comprise any user interface.

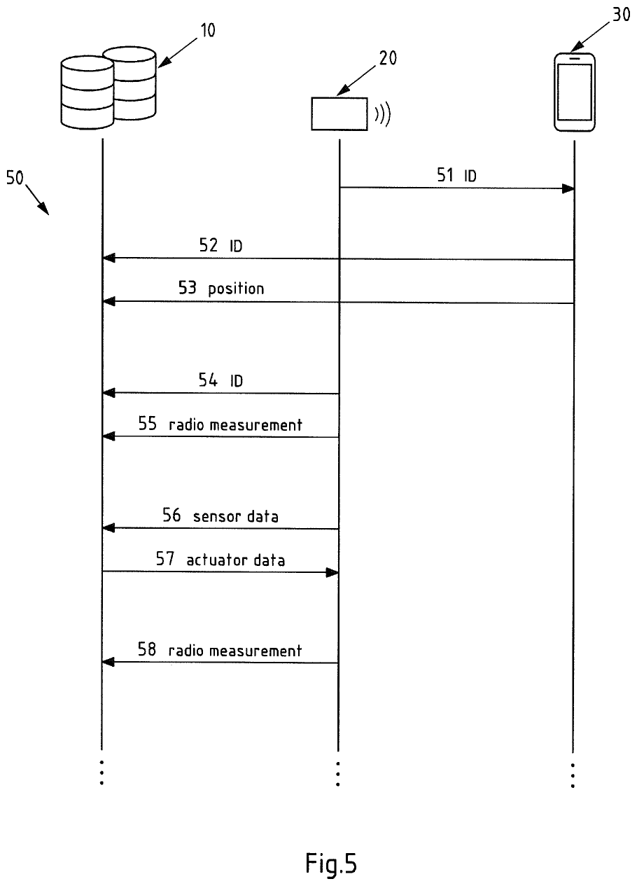

Turning now to FIG. 4, an exemplary block diagram of a mobile device 30 of FIG. 1 is shown. Similarly to FIGS. 2 and 3, mobile device 30 comprises a processor 31. Processor 31 may represent a single processor or two or more processors, which are for instance at least partially coupled, for instance via a bus. Similar to FIGS. 2 and 3 processor 31 may use program memory 32 and main memory 33 to execute a program code stored in program memory 32 (for instance program code causing mobile device 30 to perform embodiments of the (third) method according to the third aspect of the invention, when executed on processor 31).

Processor 31 further controls a communication interface 34 configured to receive and/or send information. For instance, mobile device 30 may be configured to communicate with server 10 and/or sensor/actuator device 20 of system 1 of FIG. 1. This may for instance comprise sending identifier information and/or positioning information. Additionally, this may for instance comprise receiving identifier information. The communication may for instance be based on a (e.g. partly) wireless connection. The communication interface 34 may thus comprise circuitry such as modulators, filters, mixers, switches and/or one or more antennas to allow transmission and/or reception of signals. In embodiments of the invention, communication interface 34 is inter alia configured to allow communication according to a 2G/3G/4G/5G cellular communication system and/or a non-cellular communication system, such as for instance a WLAN network. Specifically, the communication interface 34 may configured for communication over a LPWAN.

Processor 31 further controls a user interface 35 configured to present information to a user of mobile device 30 and/or to receive information from such a user, such as manually input position fixes or the like. User interface 34 may for instance be the standard user interface via which a user of mobile device 30 controls other functionality thereof, such as making phone calls, browsing the Internet, etc.

Processor 31 may further control a GNSS interface 36 configured to receive positioning information of an GNSS such as Global Positioning System (GPS), Galileo, Global Navigation Satellite System (i.e. “Globalnaja Nawigazionnaja Sputnikowaja Sistema”, GLONASS) and Quasi-Zenith Satellite System (QZSS). It should be noted that, even in case mobile device 30 has a GNSS interface 36, a position of the mobile device 30 may additionally or alternatively be determined with positioning technologies based on other approaches, such as the approach based on radio measurements of communication networks supported by the communication interface 34 or inertial sensors, since these technologies may provide a higher accuracy in challenging environments for GNSS-based technologies.

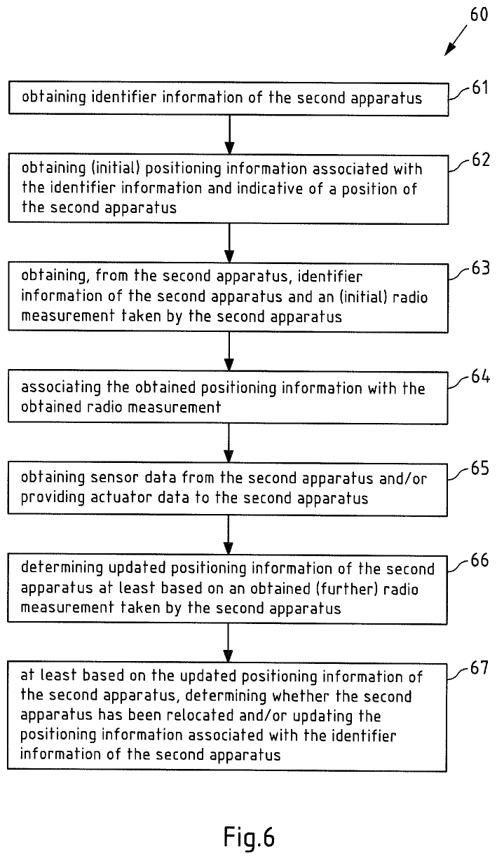

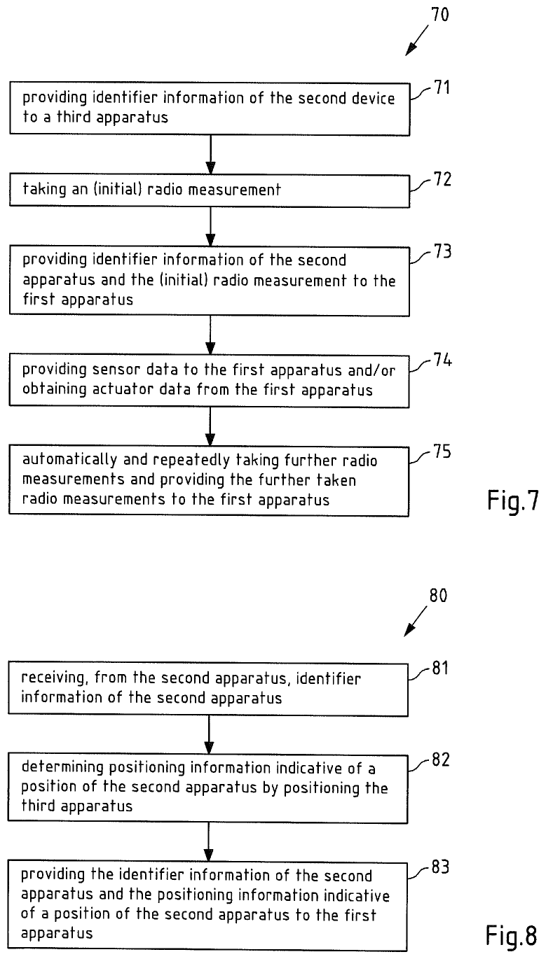

Exemplary embodiments of the different methods according to the different aspects will now be described together with reference to FIGS. 5-8. Therein, FIG. 5 is a flow chart 50 illustrating the sending and receiving of information between the different apparatuses 10, 20, 30 when performing exemplary methods according to the different aspects. FIG. 6 is flow chart 60 illustrating an exemplary embodiment of a (first) method according to the first aspect, FIG. 7 is flow chart 70 illustrating an exemplary embodiment of a (second) method according to the second aspect, and FIG. 8 is a flow chart 80 illustrating an exemplary embodiment of a (third) method according to the third aspect.

A procedure for registering a sensor/actuator device 20 with the server 10 may be started at the mobile device 30. In the described embodiment, the sensor/actuator device 20 may comprise an NFC tag storing identifier information (e.g. a unique identifier, e.g. sensor no. 123) of the sensor/actuator device 20. Thus, in action 51 the sensor/actuator device 20 may provide identifier information of the sensor/actuator device 20 to the mobile device 30 (action 71). The mobile device 30 may in turn receive the identifier information from the sensor/actuator device (action 81). For this, an app of the mobile device 30 may read the NFC tag of the sensor/actuator device 20.

The mobile device 30 determines positioning information by positioning itself (action 82). Since the mobile device 30 is at or close to the sensor/actuator device 20, the position information is indicative of a position of the sensor/actuator device 20. This may be done using the best positioning technology available at the mobile device 30, e.g. any indoor/outdoor, online/offline positioning method e.g. based on one or more of GNSS, WLAN, Bluetooth, a cellular communication system, etc.

The mobile device 30 then sends the identifier information of the sensor/actuator device 20 (e.g. sensor no. 123) and the determined positioning information indicative of a position of the sensor/actuator device 20 to server 10 (back-end) (actions 52, 53 and action 83). Server 10 obtains the identifier information (action 61) and the (initial) positioning information associated with the identifier information and indicative of a position of the sensor/actuator device 20 (action 62). Thus, server 10 is notified about the registering or installation of a new sensor/actuator device 20.

Server 10 stores the position information and waits for the respective sensor/actuator device 20 (i.e. sensor/actuator device no. 123) to register itself at the server.

When the sensor/actuator device 20 is turned on, it connects automatically to the server 10 using, e.g. an NB-IoT connection. Also, the sensor/actuator device 20 scans the radio environment (in this case the NB-IoT environment) and takes an (initial) radio measurement (action 72).

The sensor/actuator device 20 then provides the identifier information and the (initial) radio measurement to server 10 (actions 54, 55 and action 73). Accordingly, the server 10 obtains the identifier information of the sensor/actuator device 20 and the (initial) radio measurement taken (action 62). This process constitutes a crowd sourcing.

Server 10 then associates the obtained positioning information with the obtained radio measurement (action 64). In this way, accurate positioning information from the mobile device 30 and the radio environment measurement (e.g. NB-IoT scan information) from the sensor/actuator device 20 can be combined at the back-end. The server 10 can then create and/or update an (e.g. NB-IoT) positioning radio database.

The sensor/actuator device 20 now sends or reports sensor data from sensor 26 e.g. to server 10 and/or receives actuator data for actuator 27 e.g. from server 10 (actions 56, 57 and action 74). Accordingly, server 10 receives the sensor data from the sensor/actuator device 20 and/or provides actuator data to the sensor/actuator device 20 (action 65). This may be considered as the original or main task of sensor/actuator device 20.

Sensor/actuator device 20 now automatically and repeatedly takes further radio measurements of the environment and sends the further taken radio measurements to server 10 (action 58 and action 75).

Based on these obtained (further) radio measurements taken by the sensor/actuator device 20, server 10 determines updated positioning information of sensor/actuator device 20 (action 66).

Based on the updated positioning information, server 10 can now determine whether the sensor/actuator device 20 has been relocated (action 67) and e.g. provide an alert.

Additionally or alternatively, server can update the positioning information associated with the identifier information of sensor/actuator device 20 (action 67).

Thus, if the sensor is relocated (e.g. because the service crew changes the location of the sensor), the described system (in particular server 10) can automatically notice that the sensor/actuator device 20 has moved and can update the stored location of the sensor/actuator device 20 to the back-end system.

The described approach has in particular the following advantages:
it allows for an easy installation of the sensor/actuator devices 20;
it allows for tracking the location of the sensor/actuator devices 20 in real-time;
it allows for an easy relocation of the sensor/actuator devices 20; and
it allows for creating alerts if a sensor/actuator device 20 is moved.

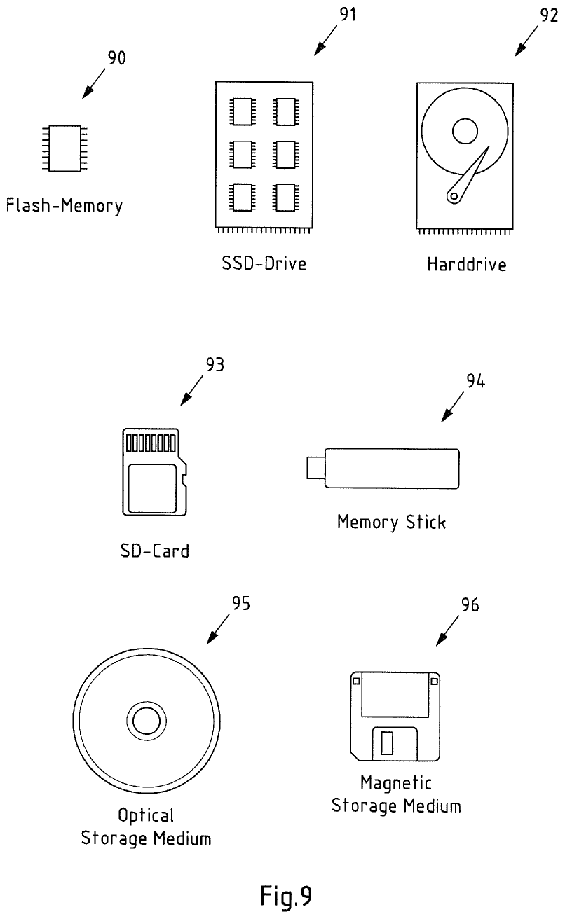

FIG. 9 is a schematic illustration of examples of tangible storage media according to the present invention, that may for instance be used to implement program memory of FIGS. 2-4. To this end, FIG. 8 displays a flash memory 90, which may for instance be soldered or bonded to a printed circuit board, a solid-state drive 91 comprising a plurality of memory chips (e.g. Flash memory chips), a magnetic hard drive 92, a Secure Digital (SD) card 93, a Universal Serial Bus (USB) memory stick 94, an optical storage medium 95 (such as for instance a CD-ROM or DVD) and a magnetic storage medium 96.

The following embodiments shall also be considered disclosed:

1. A method, performed by at least a first apparatus, for managing at least a second apparatus, the second apparatus being a sensor and/or actuator device or a part thereof, the method comprising:
obtaining identifier information of the second apparatus and obtaining positioning information indicative of a position of the second apparatus and associated with the identifier information;
determining updated positioning information of the second apparatus at least based on an obtained radio measurement taken by the second apparatus; and
at least based on the updated positioning information of the second apparatus, determining whether the second apparatus has been relocated and/or updating the positioning information associated with the identifier information of the second apparatus.

2. The method of embodiment 1, further comprising:
obtaining sensor data from the second apparatus and/or providing actuator data to the second apparatus.

3. The method of embodiment 1 or 2, wherein the identifier information of the second apparatus is obtained from a third apparatus, the third apparatus having obtained the identifier information from the second apparatus.

4. The method of embodiment 3, wherein the identifier information is obtained at the third apparatus from the second apparatus based on radio-frequency identification technology.

5. The method of any of the preceding embodiments, wherein the obtained positioning information indicative of a position of the second apparatus is obtained from a third apparatus.

6. The method of any of the preceding embodiments, wherein the obtained positioning information indicative of a position of the second apparatus is determined by positioning a third apparatus.

7. The method of embodiment 6, wherein the positioning of the third apparatus is based on at least one of
a cellular communication system;
a non-cellular communication system; and/or
a global satellite navigation system.

8. The method of any of embodiments 3 to 7, wherein the third device communicates with the first apparatus at least in part based on at least one of
a cellular communication system; and/or
a non-cellular communication system.

9. The method of any of embodiments 3 to 8, wherein the third apparatus is a mobile device or a part thereof.

10. The method of any of the preceding embodiments, further comprising:
obtaining, from the second apparatus, identifier information of the second apparatus and a radio measurement taken by the second apparatus,
associating the obtained positioning information with the obtained radio measurement.

11. The method of any of the preceding embodiments, wherein the second apparatus communicates with the first apparatus at least in part via a low power wide area network.

12. The method of any of the preceding embodiments, wherein the radio measurements taken by the second apparatus are based on signals of a low power wide area network.

13. The method of embodiments 11 or 12, wherein the low power wide area network is based on at least one of:
a chirp spread spectrum based system;
a LoRa based system;
an ultra narrow band based system;
a Sigfox system;
a Telensa system;
a NarrowBand-IoT system;
an Nwave system;
a Weightless system.

14. The method of any of the preceding embodiments, wherein the first and the third apparatus communicate at least in part via a first communication system and wherein the first and the second apparatus communicate at least in part via a second communication system, wherein the second communication system utilizes a lower data rate and/or allows for a lower power consumption for communication than the first communication system.

15. The method of any of the preceding embodiments, wherein the first apparatus provides or triggers providing an alert, in case it is determined that the second apparatus has been relocated.

16. The method of any of the preceding embodiments, wherein the first apparatus is a server or a part thereof.

17. The method of any of the preceding embodiments, wherein the method is performed for a plurality of second apparatuses.

18. A method for supporting managing at least a second apparatus at a first apparatus, the second apparatus being a sensor and/or actuator device, the method performed by the second apparatus, the method comprising:
providing identifier information of the second device to a third apparatus;
taking a radio measurement;
providing identifier information of the second apparatus and the radio measurement to the first apparatus;
providing sensor data to the first apparatus and/or obtaining actuator data from the first apparatus;
automatically and repeatedly taking further radio measurements and providing the further taken radio measurements to the first apparatus.

19. A method for registering at least a second apparatus at a first apparatus, the second device being a sensor and/or actuator device, the method performed by a least a third apparatus, the method comprising:
receiving, from the second apparatus, identifier information of the second apparatus;
determining positioning information indicative of a position of the second apparatus by positioning the third apparatus; and
providing the identifier information of the second apparatus and the positioning information indicative of a position of the second apparatus to the first apparatus.

20. An apparatus comprising means for performing a method according to any of embodiments 1 to 19.

21. An apparatus comprising at least one processor and at least one memory including computer program code, the at least one memory and the computer program code configured to, with the at least one processor, cause the apparatus to at least perform the method of any of embodiments 1 to 19.

22. A computer program code, the computer program code, when executed by a processor, causing an apparatus to perform the method of any of the embodiments 1 to 19.

23. A non-transitory computer readable storage medium in which computer program code is stored, the computer program code when executed by a processor causing at least one apparatus to perform the method of any of embodiments 1 to 19.

24. A system comprising:
a first apparatus;
a second apparatus; and
optionally a third apparatus;
the first apparatus, the second apparatus and the optionally third apparatus together being configured for performing a method according to any of embodiments 1 to 19.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors of FIGS. 2 and 3, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1. A method, performed by at least a first apparatus, for managing at least a second apparatus, the second apparatus being a sensor and/or actuator device or a part thereof, the method comprising:
obtaining identifier information of the second apparatus and obtaining positioning information indicative of a position of the second apparatus and associated with the identifier information;
determining updated positioning information of the second apparatus at least based on an obtained radio measurement taken by the second apparatus; and
at least based on the updated positioning information of the second apparatus, determining whether the second apparatus has been relocated and/or updating the positioning information associated with the identifier information of the second apparatus.

2. The method of claim 1, further comprising:
obtaining sensor data from the second apparatus and/or providing actuator data to the second apparatus.

3. The method of claim 1, wherein the identifier information of the second apparatus is obtained from a third apparatus, the third apparatus having obtained the identifier information from the second apparatus.

4. The method of claim 3, wherein the identifier information is obtained at the third apparatus from the second apparatus based on radio-frequency identification technology.

5. The method of claim 1, wherein the obtained positioning information indicative of a position of the second apparatus is obtained from a third apparatus.

6. The method of claim 1, wherein the obtained positioning information indicative of a position of the second apparatus is determined by positioning a third apparatus.

7. The method of claim 6, wherein the positioning of the third apparatus is based on at least one of
a cellular communication system;
a non-cellular communication system; and/or
a global satellite navigation system.

8. The method of claim 3, wherein the third device communicates with the first apparatus at least in part based on at least one of
a cellular communication system; and/or
a non-cellular communication system.

9. The method of claim 3, wherein the third apparatus is a mobile device or a part thereof.

10. The method of claim 1, further comprising:
obtaining, from the second apparatus, identifier information of the second apparatus and a radio measurement taken by the second apparatus,
associating the obtained positioning information with the obtained radio measurement.

11. The method of claim 1, wherein the second apparatus communicates with the first apparatus at least in part via a low power wide area network.

12. The method of claim 1, wherein the radio measurements taken by the second apparatus are based on signals of a low power wide area network.

13. The method of claim 11, wherein the low power wide area network is based on at least one of:
a chirp spread spectrum based system;
a LoRa based system;
an ultra narrow band based system;
a Sigfox system;
a Telensa system;
a NarrowBand-IoT system;
an Nwave system; or
a Weightless system.

14. The method of claim 1, wherein the first and the third apparatus communicate at least in part via a first communication system and
wherein the first and the second apparatus communicate at least in part via a second communication system, wherein the second communication system utilizes a lower data rate and/or allows for a lower power consumption for communication than the first communication system.

15. The method of claim 1, wherein the first apparatus provides or triggers providing an alert, in case it is determined that the second apparatus has been relocated.

16. The method of claim 1, wherein the first apparatus is a server or a part thereof.

17. The method of claim 1, wherein the method is performed for a plurality of second apparatuses.

18. A method for supporting managing at least a second apparatus at a first apparatus, the second apparatus being a sensor and/or actuator device, the method performed by the second apparatus, the method comprising:
providing identifier information of the second apparatus to a third apparatus;
taking a radio measurement;
providing identifier information of the second apparatus and the radio measurement to the first apparatus;
providing sensor data to the first apparatus and/or obtaining actuator data from the first apparatus; and
automatically and repeatedly taking further radio measurements and providing the further taken radio measurements to the first apparatus.

19. (canceled)

20. (canceled)

21. An apparatus configured to manage at least a second apparatus, the second apparatus being a sensor and/or actuator device or a part thereof, the apparatus comprising at least one processor and at least one memory including computer program code, the at least one memory and the computer program code configured to, with the at least one processor, cause the apparatus;
obtain identifier information of the second apparatus and obtain positioning information indicative of a position of the second apparatus and associated with the identifier information;
determine updated positioning information of the second apparatus at least based on an obtained radio measurement taken by the second apparatus; and
at least based on the updated positioning information of the second apparatus, determine whether the second apparatus has been relocated and/or update the positioning information associated with the identifier information of the second apparatus.

22. (canceled)

23. (canceled)

24. (canceled)

25. The apparatus of claim 21, wherein the at least one memory and the computer program code are further configured to, with the at least one processor, cause the apparatus to:
obtain sensor data from the second apparatus and/or provide actuator data to the second apparatus.
